(19) United States
(12) Patent Application Publication
(10) Pub. No.: US 2012/0170528 A1
(43) Pub. Date: Jul. 5, 2012

(54) METHOD FOR POLLING A MESSAGE IN AN INSTANT MESSENGER AND A MOBILE DEVICE ADAPTED TO THE METHOD

(75) Inventor: Kye Hwan LEE, Suwon-si (KR)

(73) Assignee: SAMSUNG ELECTRONICS CO. LTD., Suwon-si (KR)

(21) Appl. No.: 13/279,690

(22) Filed: Oct. 24, 2011

(30) Foreign Application Priority Data
Jan. 5, 2011 (KR) 10-2011-0000951

(51) Int. Cl. H04W 74/06; H04L 12/403

(52) U.S. Cl. 370/329; 370/449

(57) ABSTRACT

A message polling method and a system using an instant messenger are provided. The method includes executing the instant messenger, and connecting to a server, when a polling period has elapsed, and attempting to acquire a message. The polling period is set as an average time with respect to a time that elapsed until successfully acquiring each of one or more messages during a preset polling period determining interval. The method and system can dynamically set a polling period by determining, as the polling period, an average time calculated from a time that is required to successfully acquire each of one or more messages during a preset polling-period determining interval. This allows the client to reduce the consumption of electrical power of the battery and to minimize the cost of data packets used.

### PRIORITY

This application claims the benefit under 35 U.S.C. §119(a) of a Korean patent application filed on Jan. 5, 2011 in the Korean Intellectual Property Office and assigned Serial No. 10-2011-0000951, the entire disclosure of which is hereby incorporated by reference.

### BACKGROUND OF THE INVENTION

1. Field of the Invention

The present invention relates to polling systems. More particularly, the present invention relates to a method and a system for dynamically setting a polling period by determining an average time calculated from a time that is required to successfully acquire each of one or more messages during a preset polling-period determining interval.

2. Description of the Related Art

Instant messenger is a form of real-time direct text-based communication means between two or more people, using clients, via a network, such as the Internet, etc. Instant messenger is called messenger in short or Internet messenger because it is used over the Internet.

Instant messenger requires a server-client system. However, when a commercial server does not support a push function, a client must periodically connect to a server in order to acquire messages to be transmitted from the server. This is called a polling process. Depending on the polling periods, a client consumes different amounts of electrical power and is charged different prices for data packets.

However, systems of the related art set the polling period in a static manner. That is, a client of the related art is set with a default polling period that was previously set. Therefore, the client must periodically connect to the server with the default polling period to determine whether the server has stored messages to be transmitted to the client.

As such, polling systems of the related art are disadvantageous in that they set the polling period without considering a number of variable factors, such as the frequency of a user using messenger, a network state, etc. For example, a client may perform the polling too frequently so that they rapidly consume electrical power and are also charged a high price for data packets. In contrast, a client may perform the polling too infrequently so that they do not acquire messages in a timely manner.

Therefore, a need exists for a method and a system for dynamically setting a polling period by determining an average time calculated from time that is required to successfully acquire each of one or more messages during a preset polling- period determining interval.

### SUMMARY OF THE INVENTION

Aspects of the present invention are to address at least the above-mentioned problems and/or disadvantages and to provide at least the advantages described below. Accordingly, an aspect of the present invention is to provide a method and a system for dynamically setting a polling period by determining an average time calculated from a time that is required to successfully acquire each of one or more messages during a preset polling-period determining interval.

In accordance with an aspect of the present invention, a method for polling a message in an instant messenger is provided. The method includes executing the instant messenger, and connecting to a server, when a polling period has elapsed, and attempting to acquire a message. The polling period is set as an average time with respect to a time that elapsed until successfully acquiring each of one or more messages during a preset polling period determining interval.

In accordance with another aspect of the present invention, a mobile device is provided. The mobile device includes a Radio Frequency (RF) communication unit, a storage unit for storing an instant messenger program, and a controller for detecting the execution of the instant messenger, for determining whether a polling period has elapsed, for connecting to the server, via the RF communication unit, when the polling period has elapsed, and for acquiring a message from the server. The polling period is set as an average time with respect to a time that elapsed until successfully acquiring each of one or more messages during a preset polling period determining interval.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a mobile device periodically connecting to a server and acquiring messages according to an exemplary embodiment of the present invention;

FIG. 2 illustrates a block diagram of a mobile device according to an exemplary embodiment of the present invention;

FIGS. 3 and 4 illustrate examples of a structure of a message receiving list that uses a structure pointer according to exemplary embodiments of the present invention;

FIG. 5 is a flowchart illustrating a method for dynamically updating a polling period in a controller of a mobile device according to an exemplary embodiment of the present invention;

FIG. 6 is a flowchart illustrating a process of recording an elapsed time until acquiring a message according to an exemplary embodiment of the present invention;

FIG. 7 is a flowchart illustrating a process of updating a polling period according to an exemplary embodiment of the present invention; and

FIG. 8 is a table illustrating experimental values for a number of polling messages and lost messages according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well- known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a method and a system that can dynamically set a polling period by determining, as the polling period, an average time calculated from a time that is required to successfully acquire each of one or more messages during a preset polling-period determining interval.

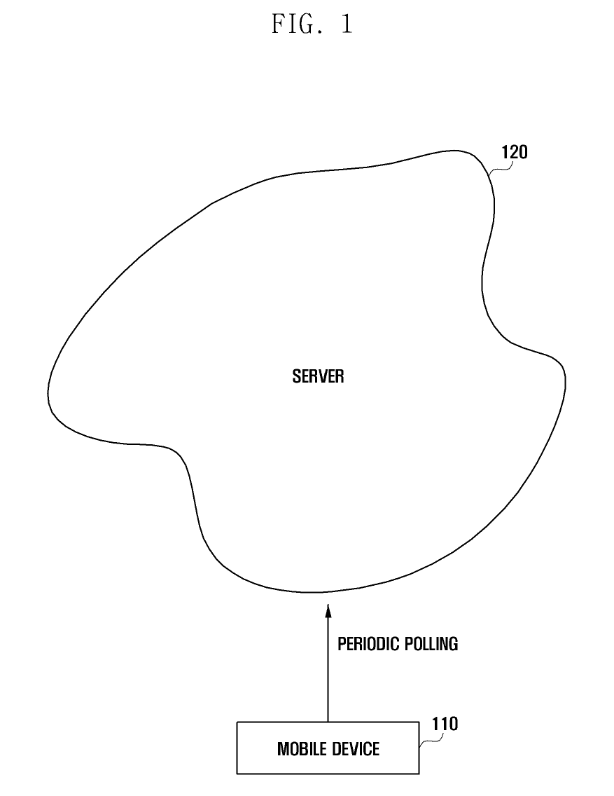

FIGS. 1 through 8, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 illustrates a mobile device periodically connecting to a server and acquiring messages according to an exemplary embodiment of the present invention.

Referring to FIG. 1, a mobile device 110 includes an instant messenger installed thereon. When the instant messenger is executed, the mobile device 110 connects to a server 120 with a preset polling period and determines whether the server 120 has stored messages to be transmitted to the mobile device 110. The polling period may be an average time with respect to a time that elapsed from a time point that the mobile device 110 connects to the server 120 until a time point that the mobile device 110 successfully acquires each of one or more messages therefrom, during a polling period determining interval. For example, the polling period determining interval may be 10 days.

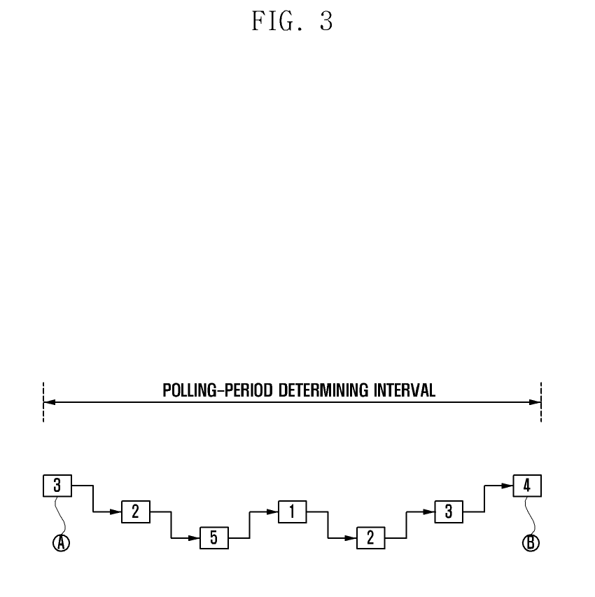

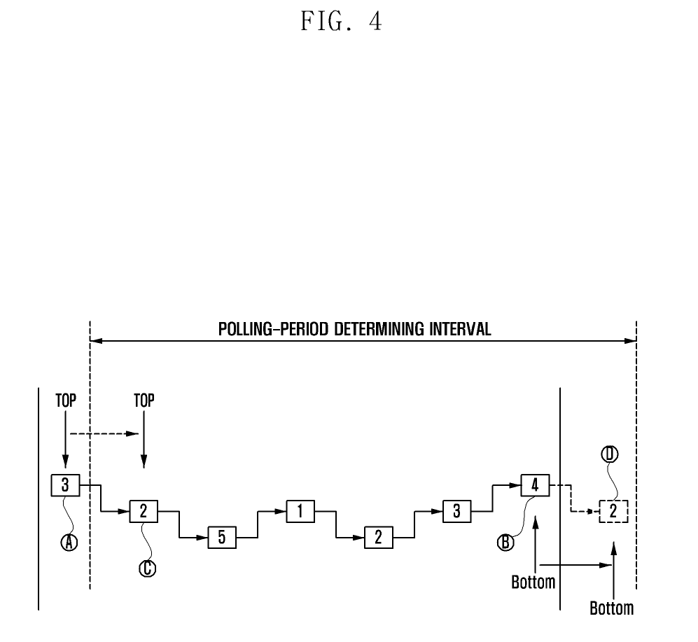

The mobile device 110 may include a list of received messages in order to dynamically update the polling period. The message receiving list is formed by a structure pointer with a number of nodes, each node storing a time interval to require a message. The structure of the message receiving list will be described later, referring to FIGS. 3 and 4.

The server 120 has stored messages to be transmitted to the mobile device 110. The server 120 transmits the stored messages to the mobile device 110, in response to a message transmission request from the mobile device 110.

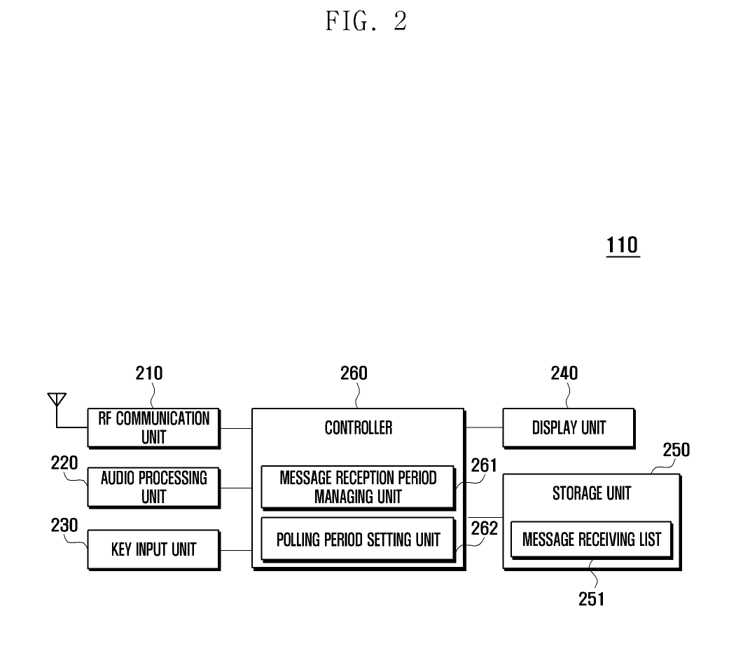

FIG. 2 illustrates a block diagram of a mobile device according to an exemplary embodiment of the present invention.

Referring to FIG. 2, the mobile device 110 includes a Radio Frequency (RF) communication unit 210, an audio processing unit 220, a key input unit 230, a display unit 240, a storage unit 250, and a controller 260.

The RF communication unit 210 wirelessly transmits and receives data to and from other communication systems. The RF communication unit 210 includes an RF transmitter, for up-converting the frequency of signals to be transmitted and amplifying the signals, and an RF receiver, for low-noise amplifying received RF signals and down-converting the frequency of the received RF signals. The RF communication unit 210 receives data via an RF channel and outputs it to the controller 260. The RF communication unit 210 also transmits data, output from the controller 260, via the RF channel.

The audio processing unit 220 includes COders and DECoders (CODECs). The CODECs are comprised of a data CODEC for processing packet data and an audio CODEC for processing audio signals, such as voice signals, etc. The audio CODEC converts digital audio signals into analog audio signals and outputs them via a speaker. The audio CODEC also converts analog audio signals, received via a microphone, into digital audio signals.

The key input unit 230 receives a user's key operations to control the mobile device 110, creates the input signals, and outputs them to the controller 260. The key input unit 230 may be implemented with a key pad with a number of alpha- numeric keys and direction keys. The key input unit 230 may also be implemented with a function key at one side of the mobile device 110.

The display unit 240 may be implemented with a Liquid Crystal Display (LCD), an Organic Light Emitting Diode (OLED), an Active Matrix Organic Light Emitting Diodes (AMOLED), or the like. The display unit 240 displays menus, input data, function-setting information, and additional information of the mobile device 110. For example, the display unit 240 displays a booting screen, an idle screen, a menu screen, a call screen, and application executing screens of the mobile device 110. The display unit 240 displays messages received from or transmitted to the other user via the instant messenger.

The storage unit 250 stores programs required to operate the mobile device 110 and data generated when the programs are executed. The storage unit 250 includes a message receiving list 251. The storage unit 250 is comprised of a program storage area and a data storage area.

The program storage area stores a program for controlling the entire operation of the mobile device 110, an Operating System (OS) for booting the mobile device 110, an application program for reproducing multimedia contents, and application programs that are used for other optional functions of the mobile device 110, such as a camera function, an audio playback function, an image or video playback function, etc. The program storage area stores an instant messenger program.

The data storage area stores data that is generated when the mobile device 100 is used, for example, images, video images, a phone book, audio data, etc. The data storage area stores messages acquired from the server 120.

The storage unit 250 stores a message receiving list used to dynamically update a polling period. The message receiving list is formed by a structure pointer with a number of nodes, each node storing a time interval to require a message.

The controller 260 controls the entire operation of the components in the mobile device 110. The controller 260 connects to the server 120 to determine whether the server 120 has stored messages to be transmitted to the mobile device 110. When the controller 260 ascertains that the server 120 has stored messages to be transmitted to the mobile device 110, it performs a control operation to download the messages.

The controller 260 controls a series of operations to dynamically set a polling period by determining an average time calculated from time periods that elapsed from a time point that the mobile device 110 connects to the server 120 until a time point that the mobile device 110 successfully acquires each of one or more messages therefrom, during a preset polling-period determining interval. To this end, the controller 260 includes a message reception period managing unit 261 and a polling period setting unit 262.

The message reception period managing unit 261 stores a time that elapses from a time point that the mobile device 110 connects to the server 120 until a time point that the mobile device 110 successfully acquires a message therefrom. More particularly, the message reception period managing unit 261 stores an elapsed time to acquire a message in the message receiving list via the structure pointer. The structure pointer used by the message reception period managing unit 261 is shown in the following Table 1.

TABLE 1

Structure *Receive_time{
int time;
Receive_time *link
}

As shown in Table 1, the variable ‘time’ refers to a time that elapsed from a time point that a message is acquired until a time point that the next message is acquired. The ‘link’ refers to a following node to store the variable ‘time.’

FIGS. 3 and 4 illustrate examples of a structure of a message receiving list that uses a structure pointer according to exemplary embodiments of the present invention.

Referring to FIG. 3, the message receiving list is comprised of a polling period determining interval and a number of nodes in the interval.

The polling period determining interval refers to an interval to calculate an average time to determine a polling period. The length of the polling period determining interval is set according to the top node, Node A, and the bottom node, Node B. The message reception period managing unit 261 starts to store, in the top node, i.e., Node A, a time that elapsed from a time point that the mobile device 110 connects to the server 120 until a time point that it acquires the first message therefrom, and stores a time that elapsed to acquire another message in the next node. More specifically, when the message reception period managing unit 261 stores a time that elapsed to acquire the first message in the top node, i.e., Node A, the next node is designated. In that case, the message reception period managing unit 261 stores a time that elapsed until acquiring the next message in the next node. In an exemplary implementation, a time that elapsed until acquiring the first message is 3 minutes, a time until acquiring the next message is 2 minutes, and a time until acquiring the third message is 5 minutes.

The polling period determining interval may be varied according to a mobile device user's settings or a mobile device manufacturer's settings. For example, although the polling period determining interval includes seven nodes, as shown in FIG. 3, it may be set variably to include different number of nodes according to the frequency of a user using messenger, a network state, etc. For example, the polling period determining interval may be 10 days, one month, or the like.

Referring to FIG. 4, although data (time that elapsed until acquiring messages) for all nodes in the polling period determining interval is stored, the message reception period managing unit 261 needs to continue updating a message receiving list. In that case, the message reception period managing unit 261 disconnects from the top node, Node A, and sets a node, Node C, closest to the top node as a new top node. Simultaneously, the message reception period managing unit 261 creates the bottom node B as the next node, Node D, and sets Node D as a new bottom node. As such, the message reception period managing unit 261 continues updating the message receiving list.

The polling period setting unit 262 sets a polling period at which the mobile device 110 connects to the server 120. To this end, the polling period setting unit 262 identifies the nodes in the polling period determining interval when setting a polling period. The polling period setting unit 262 adds up the time recorded in the identified nodes and divides the added time by the number of nodes in the polling period determining interval. The polling period setting unit 262 sets a polling period as per Equation 1, which is shown below.

Polling period=summation of the time recorded in the nodes in the polling period determining interval/the number of nodes in the polling period determining interval Equation 1

The polling period setting unit 262 sets the polling period acquired via Equation 1 as a new polling period. In that case, the mobile device 110 connects to the server 120 according to the new polling period and acquires a message therefrom.

When the message receiving list shown in FIG. 3 is applied to the formula of the polling period described in Equation 1, a new polling period is approximately 2.85 minutes, acquired as per Equation 2, which is shown below.

New polling period=(3+2+5+1+2+3+4)/7=2.85 Equation 2

Since a new polling period is altered each time that a message is acquired, it can be dynamically set according to the frequency of a user using messenger, a network state, etc.

As described above, although the exemplary embodiment is implemented in such a manner that the controller 260, the message reception period managing unit 261, and the polling period setting unit 262 are separated and they perform different functions, this configuration is used for the sake of convenience. That is, the functions they are performing are not always differentiated. For example, the controller 260 may perform functions that the message reception period managing unit 261 and the polling period setting unit 262 are conducting.

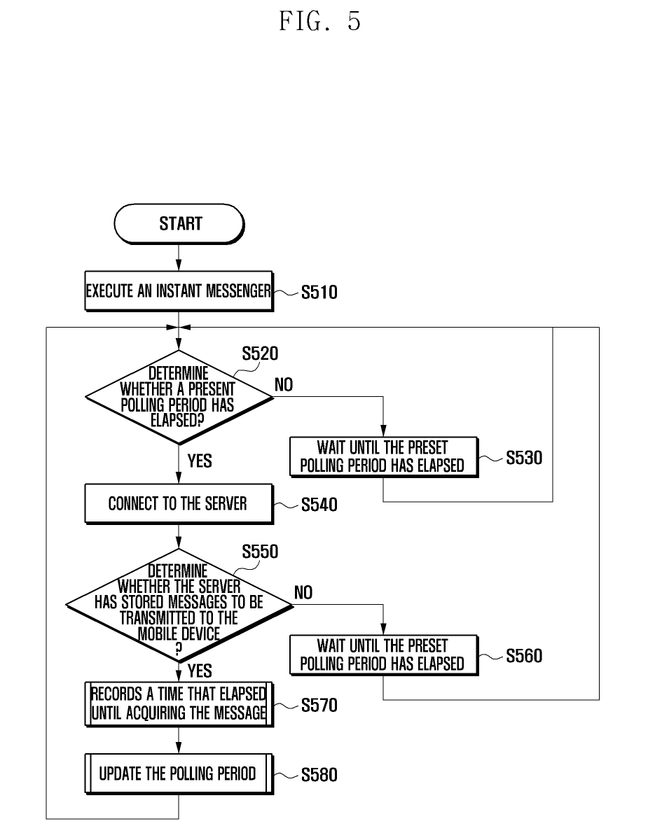

FIG. 5 is a flowchart illustrating a method for dynamically updating a polling period in a controller of a mobile device according to an exemplary embodiment of the present invention.

Referring to FIG. 5, controller 260 detects that an instant messenger is executed in the mobile device 110 at step S510. The controller 260 determines whether a present polling period has elapsed at step S520. When the instant messenger is first executed in the mobile device 110 that has been delivered from the manufacturer, the polling period may be set as a default value. Otherwise, the polling period may be a polling period that was updated when a message is acquired at a previous step.

When the controller 260 ascertains that a present polling period has not elapsed at step S520, it waits until the preset polling period has elapsed at step S530.

In contrast, when the controller 260 ascertains that a present polling period has elapsed at step S520, it connects to the server 120 at step S540. Thereafter, the controller 260 determines whether the server 120 has stored messages to be transmitted to the mobile device 110 at step S550.

When the controller 260 ascertains that the server 120 has stored messages to be transmitted to the mobile device 110 at step S550, it requests transmission of the messages to the mobile device 110 from the server 120.

Thereafter, the controller 260 records a time that elapsed until acquiring the message in the message receiving list at step S570.

The controller 260 updates the polling period, thereby creating a new polling period at step S580. The controller 260 sets the created new polling period to poll the server.

In contrast, when the controller 260 ascertains that the server 120 does not store messages to be transmitted to the mobile device 110 at step S550, it waits until the preset polling period has elapsed at step S560.

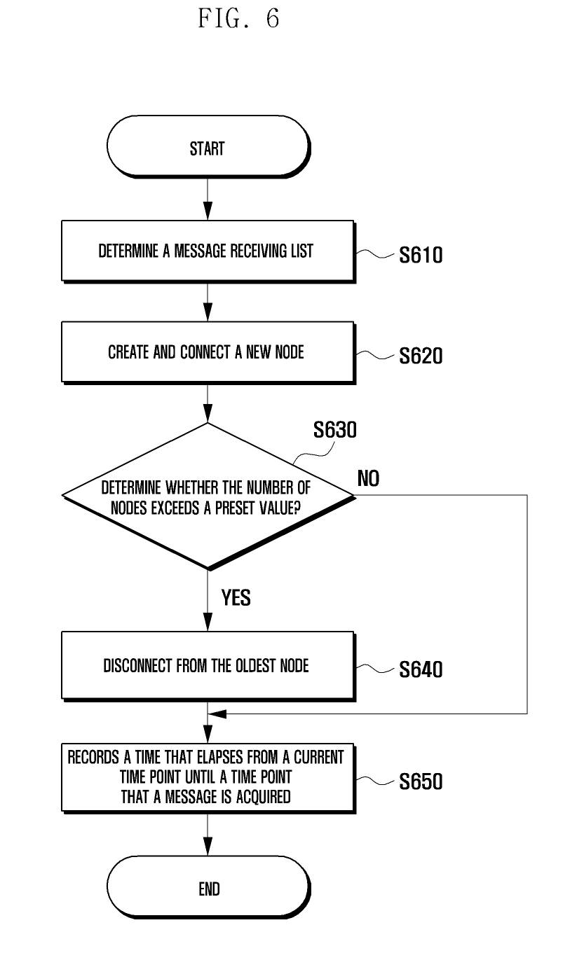

FIG. 6 is a flowchart illustrating a process of recording an elapsed time until acquiring a message according to an exemplary embodiment of the present invention.

Referring to FIG. 6, the controller 260 determines a message receiving list stored in the storage unit 250, before recording the message receiving list, at step S610. The controller 260 creates a new node to record a time that elapses to acquire a message, and connects the new node to the bottom node at step S620.

The controller 260 determines whether the number of nodes in the polling period determining interval exceeds a preset value at step S630. For example, if the polling period determining interval is one month, the controller 260 determines whether the number of nodes including a new node exceeds one month.

When the controller 260 ascertains that the number of nodes exceeds a preset value at step S630, it disconnects from the oldest node at step S640. That is, the controller 260 disconnects from the top node and sets a node, closest to the top node, as a new top node. As such, the controller 260 can keep the number of nodes in the polling period determining interval.

Thereafter, the controller 260 records, in the newly created node, a time that elapses from a current time point until a time point that a message is acquired at step S650. For example, when a previously set polling period is one minute and the controller 260 acquires a message after elapsing the polling period twice, the controller 260 can record two minutes in the new created node.

In contrast, when the controller 260 ascertains that the number of nodes does not exceed a preset value at step S630, it proceeds with step S650.

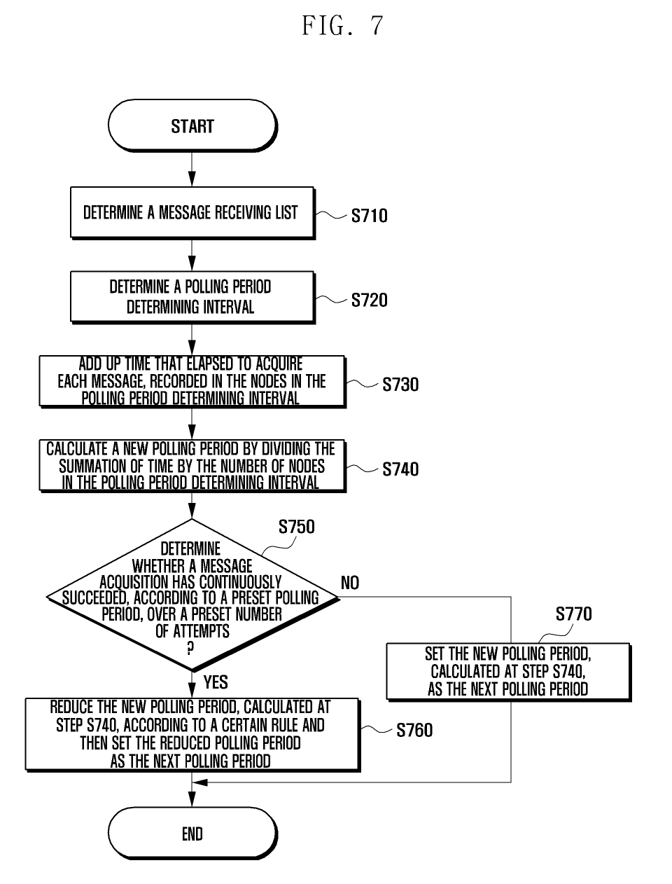

FIG. 7 is a flowchart illustrating a process of updating a polling period according to an exemplary embodiment of the present invention.

Referring to FIG. 7, the controller 260 determines a message receiving list stored in the storage unit 250 at step S710. The controller 260 also determines a polling period determining interval set in the message receiving list at step S720. During this process, the controller 260 can also determine the number of nodes in the polling period determining interval.

The controller 260 adds up a time that elapsed to acquire each message, recorded in the nodes in the polling period determining interval at step S730. The controller 260 calculates a new polling period by dividing the summation of time by the number of nodes in the polling period determining interval at step S740.

In an exemplary embodiment of the present invention, the new polling period, calculated via the steps shown in FIG. 5 and steps 710 through 740 shown in FIG. 7, only increases but cannot be decreased. That is, although the polling period may be reduced so that the mobile device 110 can frequently acquire messages from the server 120, the exemplary embodiment of the present invention is implemented in such a manner that the increased polling period cannot be decreased.

To this end, the controller 260 performs step S750 and the other steps following step S750.

The controller 260 determines whether a message acquisition has succeeded continuously, according to a preset polling period, over a preset number of attempts, at step S750. For example, when a preset polling period is 10 minutes and the mobile device 110 connects to the server 120, at the period of 10 minutes, for successive three times, and succeeds in acquiring messages, although the polling period is reduced, there may be a high probability of receiving a message.

When the controller 260 ascertains that a message acquisition has succeeded continuously over a preset number of attempts at step 750, it reduces the new polling period, calculated at step S740, according to a certain rule and sets the reduced polling period as the next polling period at step S760. For example, the controller 260 divides the new polling period by an integer, 2 or 3, and sets the calculated value as the next polling period. Alternatively, the controller 260 subtracts a certain unit of time (e.g., 1 minute, 1 hour, etc.) from the new polling period and sets the calculated value as the next polling period. It will be noted that exemplary embodiments of the present invention are not limited to the polling period setting methods described above.

In contrast, when the controller 260 ascertains that a message acquisition has not succeeded continuously over a preset number of attempts at step S750, it sets the new polling period, calculated at step S740, as the next polling period at step S770.

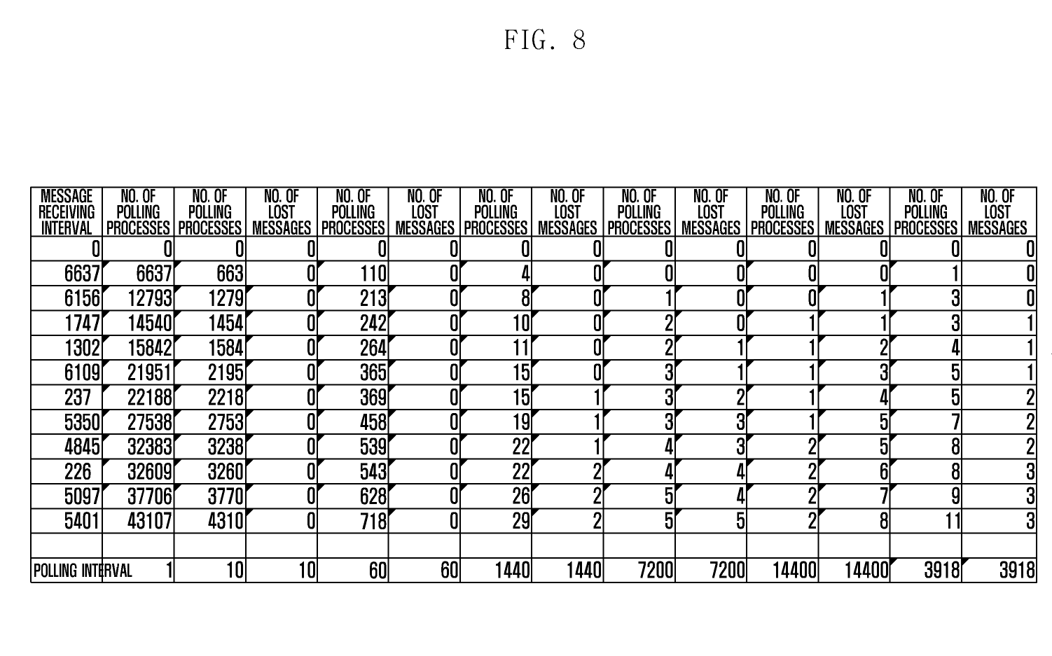

FIG. 8 is a table illustrating experimental values for a number of polling messages and lost messages according to an exemplary embodiment of the present invention. It is assumed that the mobile device 110 consumes electric power in proportion to the number of polling processes.

Referring to FIG. 8, the message receiving interval and the polling interval each have a unit of a minute. The number of polling processes is calculated by dividing the entire time by the polling interval. It is assumed that, after a message has arrived, when another message arrives before polling, the earlier message is lost.

If the message receiving interval is 6637 minutes, this denotes that the server receives messages to be transmitted to a mobile device at a period of 6637 minutes.

When the message receiving interval is 6637 minutes and a polling process is performed at a period of 1 minute, the number of polling processes is 6637 times. In that case, no messages are lost.

On the other hand, when a polling process is performed at a period of 10 minutes, the number of polling processes is 663 times. In that case, the messages are not lost.

In addition, when a polling period is 60 minutes, the number of polling processes is 110 times. In that case, the messages are not lost.

The table shown in FIG. 8 is completed by repeating the process described above.

Still referring to FIG. 8, when a polling process is performed with an average, 3918 minutes, the number (of polling processes) is 11 times and data is lost three times. On average, the polling processes are performed 10 times and data is lost two or three times. This result indicates that the polling process is more competitive than others with other polling intervals.

As described above, the method and system according to exemplary embodiments of the present invention can dynamically set a polling period by determining, as the polling period, an average time calculated from a time that is required to successfully acquire each of one or more messages during a preset polling- period determining interval. This allows the client to reduce the consumption of electrical power of the battery and to minimize the cost of data packets used.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for polling a message in an instant messenger, the method comprising:
executing the instant messenger; and
connecting, when a polling period has elapsed, to a server and attempting to acquire a message,
wherein the polling period is set as an average time with respect to a time that elapsed until successfully acquiring each of one or more messages during a preset polling period determining interval.

2. The method of claim 1, further comprising:
recording the time that elapsed until successfully acquiring the message in a message receiving list,
wherein the message receiving list is comprised of a structure pointer including a number of nodes, each node recording a time that elapsed until acquiring a corresponding message.

3. The method of claim 2, wherein the recording of the elapsed time comprises:
creating a new node and connecting the new node to the bottom node in the message receiving list; and
recording the time that elapsed until successfully acquiring the message in the new node.

4. The method of claim 3, wherein the recording of the elapsed time comprises:
disconnecting the top node and setting a node closest to the top node as a new top node.

5. The method of claim 3, further comprising:
disconnecting, when a total number of nodes exceeds a preset number, the top node from the message receiving list.

6. The method of claim 3, further comprising:
updating the polling period.

7. The method of claim 3, wherein the updating of the polling period comprises:
determining the polling period determining interval in the message receiving list;
adding time recorded in a number of nodes included in the polling period determining interval; and
calculating a new polling period by dividing the summation of time by the number of nodes included in the polling period determining interval.

8. The method of claim 7, wherein the updating of the polling period further comprises:
determining whether a message acquisition has succeeded continuously, at a preset polling period, over a preset number; and
reducing the calculated new polling period when a message acquisition has succeeded continuously.

9. A mobile device comprising:
a Radio Frequency (RF) communication unit;
a storage unit for storing an instant messenger program; and
a controller for detecting the execution of the instant messenger, for determining whether a polling period has elapsed, for connecting to the server, when the polling period has elapsed, via the RF communication unit, and for acquiring a message from the server,
wherein the polling period is set as an average time with respect to time that elapsed until successfully acquiring each of one or more messages during a preset polling period determining interval.

10. The mobile device of claim 9, wherein the storage unit comprises a message receiving list that is comprised of a structure pointer including a number of nodes, each node recording a time that elapsed until acquiring a corresponding message, and wherein the controller records the time that elapsed until successfully acquiring the message in the message receiving list.

11. The mobile device of claim 10, wherein the controller creates a new node, when recording the time, connects the new node to the bottom node in the message receiving list, and records a time that elapsed until successfully acquiring the message in the new node.

12. The mobile device of claim 11, wherein the controller, when recording the time, disconnects the top node and sets a node closest to the top node as a new top node.

13. The mobile device of claim 11, wherein the controller disconnects, when a total number of nodes exceeds a preset number, the top node from the message receiving list.

14. The mobile device of claim 11, wherein the controller updates the polling period.

15. The mobile device of claim 11, wherein the controller determines the polling period determining interval in the message receiving list, adds time recorded in a number of nodes included in the polling period determining interval, and calculates a new polling period by dividing the summation of time by the number of nodes included in the polling period determining interval.

16. The mobile device of claim 15, wherein the controller determines whether a message acquisition has succeeded continuously, at a preset polling period, over a preset number, and reduces the calculated new polling period when a message acquisition has succeeded continuously.
